(19) United States
(12) Patent Application Publication
(10) Pub. No.: US 2025/0334219 A1
(43) Pub. Date: Oct. 30, 2025

(54) BREAKAWAY PIPE CLAMP ASSEMBLY

(71) Applicant: Dustin Jaggli, Hesperia, CA (US)

(72) Inventor: Dustin Jaggli, Hesperia, CA (US)

(21) Appl. No.: 18/645,613

(22) Filed: Apr. 25, 2024

(51) Int. Cl. F16L 55/172

(52) U.S. Cl. CPC F16L 55/172

(57) ABSTRACT

A breakaway pipe clamp assembly for clamping a pipe while permitting the pipe to be replaced via a pipe bursting process includes a band which comprises a bendable material. The band has a first end and a second end, and a pair of lateral edges of the band extends between the first and second ends. The band has a weakened region which extends between the pair of lateral edges and which is configured to fail when a sufficient tension force is applied to the band transverse to the weakened region. A tightening mechanism is mounted to the band and is configured to selectively draw the first and second ends of the band toward each other.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pipe clamps and more particularly pertains to a new pipe clamp for clamping a pipe while permitting the pipe to be replaced via a pipe bursting process.

### (2) Description of Related Art Including Information Disclosed Under 37 CFR 1.97 and 1.98

The prior art discloses myriad pipe clamps such as those used to cover a break or hole in a pipe to seal the break and prevent leakage through the break. However, the prior art fails to describe such a pipe clamp which includes notches and perforations to allow the clamp to fail by splitting when a pipe bursting process is performed to replace the pipe to which the clamp is applied.

### BRIEF SUMMARY OF THE INVENTION

An embodiment of the disclosure meets the needs presented above by generally comprising a band which comprises a bendable material. The band has a first end and a second end, and a pair of lateral edges of the band extends between the first and second ends. The band has a weakened region which extends between the pair of lateral edges and which is configured to fail when a sufficient tension force is applied to the band transverse to the weakened region. A tightening mechanism is mounted to the band and is configured to selectively draw the first and second ends of the band toward each other.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective exploded view of a breakaway pipe clamp assembly according to an embodiment of the disclosure.

FIG. 2 is a front perspective view of an embodiment of the disclosure.

FIG. 3 is a rear perspective view of an embodiment of the disclosure.

FIG. 4 is a bottom view of an embodiment of the disclosure.

FIG. 5 is an in-use view of an embodiment of the disclosure depicting the embodiment being used to close a break in a pipe.

FIG. 6 is an in-use view of an embodiment of the disclosure depicting the embodiment being split open by a pipe bursting head.

### DETAILED DESCRIPTION OF THE INVENTION

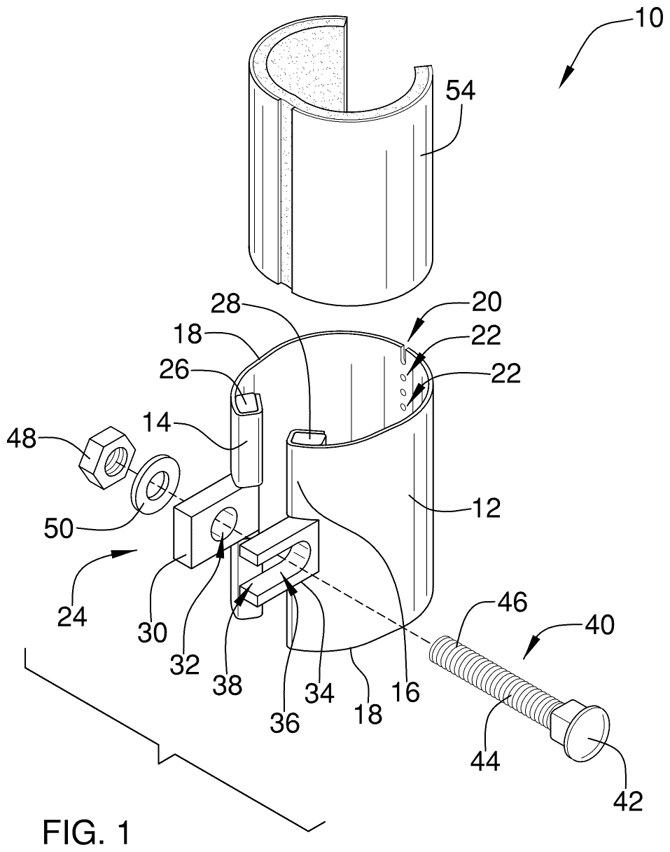

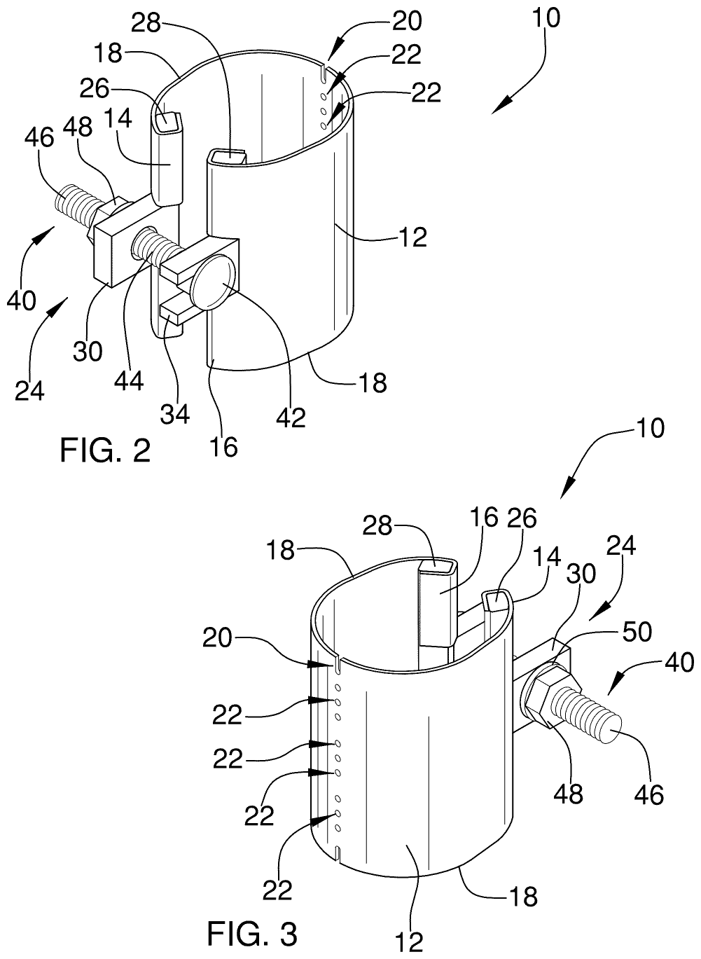

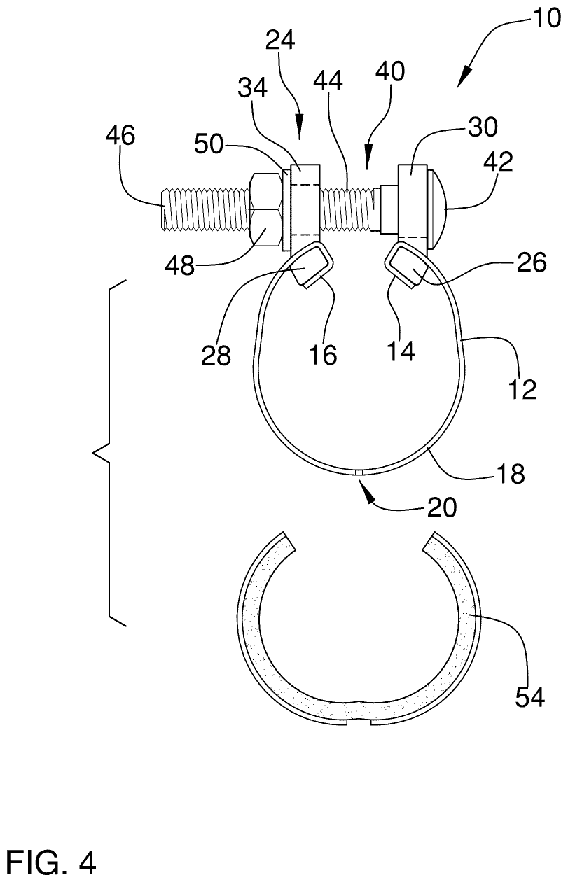

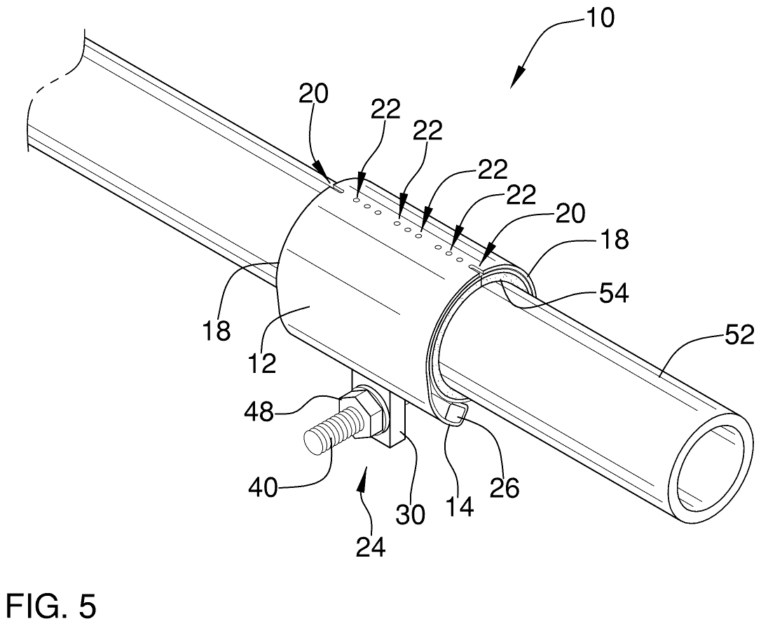

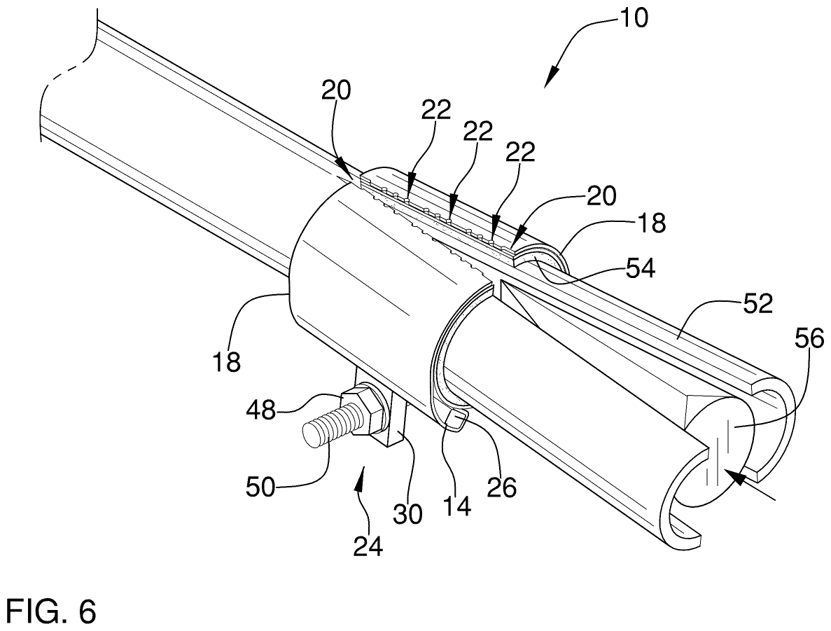

With reference now to the drawings, and in particular to FIGS. 1 through 6 thereof, a new pipe clamp embodying the principles and concepts of an embodiment of the disclosure and generally designated by the reference numeral 10 will be described.

As best illustrated in FIGS. 1 through 6, the breakaway pipe clamp assembly 10 generally comprises a band 12 which comprises a bendable material. The band 12 has a first end 14 and a second end 16. The band 12 also has a pair of lateral edges 18, each of which extends between the first and second ends 14, 16. The bendable material may be a sheet metal or any other suitable material for bending the first end 14 of the band 12 toward the second end 16 around a pipe 52 to clamp the pipe 52. The band 12 defines a pair of notches 20, each of which is positioned on an associated lateral edge 18 of the pair of lateral edges 18. The band 12 further defines a plurality of perforations 22 along a line extending between the pair of notches 20. In some embodiments, a plurality of rows of notches 20 and perforations 22 may be formed in the band 12, each of which extends between the lateral edges 18.

A tightening mechanism 24 is mounted to the band 12 which is operable to draw the first and second ends 14, 16 of the band 12 toward each other. The tightening mechanism 24 includes a first bar 26 and a second bar 28. The first end 14 of the band 12 is hooked around the first bar 26, and the second end 16 of the band 12 is hooked around the second bar 28. A first tab 30 is coupled to and protrudes away from the first bar 26, and a second tab 34 is coupled to and protrudes away from the second bar 28. The first bar 26 defines a hole 32 therein, and the second bar 28 defines a slot 36 therein which has an open end 38.

The tightening mechanism 24 further includes a bolt 40 and a nut 48 which mount to the first and second tabs 30, 34. A shaft 44 of the bolt 40 is receivable through the open end 38 of the slot 36 so that a head 42 of the bolt 40 seats against the second tab 34, and a threaded end 46 of the bolt 40 may be inserted through the hole 32 of the first tab 30. The nut 48 may threadedly couple to the threaded end 46 of the bolt 40 and seat against the first tab 30. By screwing the nut 48 onto the bolt 40, the nut 48 is moved toward the head 42 of the bolt 40, drawing the first tab 30 toward the second tab 34. A washer 50 may also be used with the nut 48 to distribute a compressive load produced by the nut 48 and the bolt 40 against the first tab 30. In other embodiments, the bolt 40 or another threaded member may thread directly into the first tab 30. Other elements also may be used to draw the first and second ends 14, 16 of the band 12 together, such as a latch, a spring or other biasing member, or the like.

In use, the breakaway pipe clamp assembly 10 may be used as a typical pipe clamp to join pipes or other cylindrical elements together. In particular, the breakaway pipe clamp assembly 10 may be used to secure a sleeve 54 of rubber, polyethylene or other suitable material on a leaky portion of the pipe 52 to plug the leak. Unlike other pipe clamps which are used for stopping leaks, the breakaway pipe clamp assembly 10 allows for replacement of the pipe 52 via a trenchless pipe bursting process. During such a process, a pipe bursting head 56 is pulled via a winch or the like through the pipe 52. The pipe bursting head 56 is tapered such that the pipe bursting head 56 is directed through the pipe 52 and has a width greater than the pipe 52 such that it causes the pipe 52 to rupture outwardly as the pipe bursting head 56 is drawn through. A new pipe is drawn behind the pipe bursting head 56 such that the new pipe takes the place of the pipe 52.

As the pipe bursting head 56 is drawn through the breakaway pipe clamp assembly 10, the pipe bursting head 56 urges the band 12 of the breakaway pipe clamp assembly 10 outwardly at one of the lateral edges 18 of the band 12. The notches 20 and the perforations 22 in the band 12 of the breakaway pipe clamp assembly 10 facilitate a concentration of stress in interior surfaces of the notches 20 and perforations 22 when the pipe bursting head 56 urges the pipe 50 and the band 12 outwardly. The concentration of stress enables the band 12 to tear along the row of perforations 22 and notches 20, whereas other pipe clamps without such features would prevent the pipe bursting head 56 from breaking through the pipe 52.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A breakaway pipe clamp assembly comprising:
a band comprising a bendable material, the band having a first end and a second end, the band having a pair of lateral edges extending between the first and second ends, the band having a weakened region extending between the pair of lateral edges, the weakened region being configured to fail when a sufficient tension force is applied to the band transverse to the weakened region; and
a tightening mechanism mounted to the band, the tightening mechanism being configured to selectively draw the first and second ends of the band toward each other.

2. The assembly of claim 1, wherein the weakened region of the band includes a notch defined by the band on one of the lateral edges thereof.

3. The assembly of claim 1, wherein the weakened region of the band includes a pair of notches defined by the band, each notch of the pair of notches being positioned on an associated lateral edge of the pair of lateral edges.

4. The assembly of claim 3, wherein the weakened region of the band further includes a plurality of perforations defined by the band, the plurality of perforations being distributed along a line extending between the pair of notches.

6. The assembly of claim 1, wherein the weakened region of the band includes a plurality of perforations defined by the band, the plurality of perforations being distributed along a line extending between the pair of lateral edges.

7. The assembly of claim 1, wherein the tightening mechanism comprises:
a first tab coupled to the first end of the band and a second tab coupled to the second end of the band; and
a threaded member being operatively coupled to the first and second tabs, the threaded member being rotatable with respect to the first and second tabs to draw the first and second tabs toward each other.

8. The assembly of claim 7, wherein:
the threaded member is a bolt which is insertable through first and second tabs such that a head of the bolt seats against one of the first and second tabs; and
a nut is threadedly mountable to a threaded end of the bolt such that the nut seats against another one of the first and second tabs.

9. The assembly of claim 8, wherein the first tab defines a hole therein and the second tab defines a slot therein, the slot having an open end.

10. The assembly of claim 7, wherein the tightening mechanism further comprises a first bar and a second bar, the first bar coupling the first tab to the first end of the band, the second bar coupling the second tab to the second end of the band, the first end of the band being hooked around the first bar, the second end of the band being hooked around the second bar.

11. A breakaway pipe clamp assembly comprising:
a band comprising a bendable material, the band having a first end and a second end, the band having a pair of lateral edges extending between the first and second ends, the band defining a pair of notches, each notch of the pair of notches being positioned on an associated lateral edge of the pair of lateral edges, the band defining a plurality of perforations along a line extending between the pair of notches; and
a tightening mechanism mounted to the band, the tightening mechanism being configured to selectively draw the first and second ends of the band toward each other, the tightening mechanism comprising:
a first bar and a second bar, the first bar being coupled to the first end of the band, the second bar being coupled to the second end of the band, the first end of the band being hooked around the first bar, the second end of the band being hooked around the second bar;
a first tab and a second tab, the first tab mounted to the first bar, the second tab mounted to the second bar, the first tab defining a hole therein, the second tab defining a slot therein, the slot having an open end;
a bolt insertable through the hole of the first tab and the slot of the second tab such that a head of the bolt seats against the second tab; and
a nut threadedly mountable to a threaded end of the bolt such that the nut seats against the first tab.
